(19) United States
(12) Patent Application Publication
(10) Pub. No.: US 2023/0344290 A1
(43) Pub. Date: Oct. 26, 2023

(54) ROTOR OF AN ELECTRIC MACHINE, AND METHOD FOR PRODUCING A ROTOR, OR A HALF-SHELL OF A ROTOR, RESPECTIVELY

(71) Applicant: Rolls-Royce Deutschland Ltd & Co KG, Blankenfelde-Mahlow (DE)

(72) Inventor: Harald MÜLLER, Gerhardshofen (DE)

(21) Appl. No.: 18/306,767

(22) Filed: Apr. 25, 2023

(30) Foreign Application Priority Data
Apr. 26, 2022 (DE) 10 2022 110 054.5

(51) Int. Cl. H02K 1/278; H02K 15/03

(52) U.S. Cl. CPC H02K 1/278; H02K 15/03

(57) ABSTRACT

Described is a rotor of an electric motor, having at least one half-shell which includes a hollow-cylindrical, radially inner region, a hollow-cylindrical, radially outer region, and a toroidal region which in the radial direction and in the circumferential direction extends between the radially inner region and the radially outer region. The toroidal region connects the radial regions to one another. The radially inner region is able to be co-rotationally connected to the electric motor. Additionally, the radially inner region, the radially outer region and the toroidal region are integrally embodied. The half-shell is reinforced by a separate component which is fixedly connected to the half-shell and comprises webs which extend between the radially inner region and the radially outer region. Furthermore proposed are a method for producing the rotor and a method for producing the half-shell of the rotor.

The present disclosure relates to a rotor of an electric machine, in particular of an electric machine of an aircraft. The present disclosure furthermore relates to a method for producing a rotor of this type, and to a method for producing a half-shell of a rotor of an electric machine.

The development of modern vehicles, such as propulsion vehicles and aircraft for instance, envisages increasing electrification of the drive trains of the vehicles. This means that the respective drive train has at least one electric machine by means of which the respective vehicle can be electrically driven in the motorized operation, or which as a generator supplies a local electric network. A drive train, by means of which the vehicle can be, in particular exclusively, driven, is also referred to as an electric drive system. Aside from the fail-safe aspect of the drive system, the output density of electric drive systems of this type is of high priority in particular in drive systems of aircraft. It is furthermore attempted to produce such electric drive systems as inexpensively as possible.

As is known, rotors, or so-called rotor hubs, of electric machines are produced by means of subtractive manufacturing methods. In the process, a blank composed of a solid material is subtractively machined during a plurality of successive manufacturing steps. In most cases, 65% to 85% of the raw material is subtracted and subsequently disposed of in the form of chips. However, such a high level of scrap is undesirably at odds with sustainability and moreover causes high production costs.

The present disclosure is based on the object of making available a rotor of an electric machine that can be inexpensively produced. The present disclosure is furthermore based on the object of achieving an inexpensive method for producing a rotor which is easy to carry out, and a method for producing a half-shell of a rotor of an electric machine.

These objects are achieved by a rotor of an electric motor, and by methods, having the features of patent claims 1, 19 and 21, respectively.

All aspects mentioned hereunder can be applied to electric machines in general, such as electric motors or generators, or else to an electric machine which can be operated as a motor and as a generator.

Provided according to a first aspect of the present disclosure is a rotor of an electric machine, having at least one half-shell. The half-shell comprises a hollow-cylindrical, radially inner region, a hollow-cylindrical, radially outer region, and a toroidal region which in the radial direction and in the circumferential direction extends between the radially inner region and the radially outer region.

The toroidal region connects the radially outer region to the radially inner region. The radially inner region is able to be co-rotationally connected to a shaft of the electric machine. Moreover, the radially inner region, the radially outer region and the toroidal region are integrally embodied. Additionally, the half-shell is reinforced by a separate component which is fixedly connected to the half-shell and comprises webs which extend between the radially inner region and the radially outer region.

The rotor according to the present disclosure is characterized by a particularly high ratio of component strength to component weight. As a result, an electric machine which is configured with a rotor according to the present disclosure is able to be made available with a high output density. Furthermore, the rotor is able to be manufactured inexpensively by means of deep drawing, flow forming and/or embossing, or able to be produced from press-molded parts, or from laser-cut sheet metal parts, without a high proportion of the raw material input being present in the form of chips after production, which is undesirable for cost reasons.

Moreover, depending on the respective specific application, it can also be provided that the rotor is manufactured by means of plastic injection-molding, or produced by means of laminating from carbon fiber-reinforced plastics material.

In principle, it is also conceivable that the component is produced from a suitable composite material, which is composed of plastics material and iron or titanium chips, for example, which are incorporated into the plastics material during an injection-molding method and increase the elastic modulus, or the strength, respectively, of the respective plastics material used so as to be suitable for the specific application.

The rotor according to the present disclosure is able to be produced with a low component weight because the webs of the separate component have to be provided only where so-called load paths run through the rotor and a higher component strength is required.

Additionally, the constructive embodiment of the rotor according to the present disclosure enables a production strategy by way of which a high reduction in terms of costs in comparison to known solutions is achieved, and a targeted adaptation of the structure, or of the topology, respectively, to required uses in various output classes of electric machines is able to be implemented.

At least one of the webs in the circumferential direction can extend between the radially inner region and the radially outer region of the half-shell, have a circular profile, and connect further webs of the separate component to one another. As a result, a further improvement in terms of the component stiffness is able to be achieved while maintaining a low component weight of the rotor.

In a further embodiment of the rotor according to the present disclosure, which is characterized by a low component weight associated with a high component stiffness, at least one of the webs, between the radially inner region and the radially outer region, at least in portions has a radial profile.

The profiles of the webs of the component can in regions form a spider web-like and/or a star-shaped structure of the component, the rotor according to the present disclosure in this way being able to be adapted in a simple manner to special load conditions.

The component here can comprise at least two webs which run in the radial direction and are preferably uniformly spaced apart from one another in the circumferential direction so as to form an at least approximately star-shaped structure. If the component is to have a spider web-like structure, webs of the star-shaped structure that run in the radial direction can be connected to one another by way of at least one annular web which runs in the circumferential direction. The component can preferably have the structure of a regular wheel net which comprises a plurality of webs which run in the radial direction and are uniformly spaced apart from one another in the circumferential direction and also a plurality of at least approximately circular webs which are arranged concentrically with one another, run in the circumferential direction and are in each case fixedly connected to the radially running webs.

A height of the webs of the separate component can vary in the radial direction between the radially inner region and the radially outer region, so as to optimize in a simple manner the component weight of the rotor while taking into account the respective specific load condition.

In this way, there is the possibility, for example, to embody the height of the webs close to the radially outer region and close to the radially inner region of the half-shell so as to be larger than between those regions when forces that are higher than in the intervening toroidal region act in each case radially outside and radially inside on the half-shell during the operation of an electric machine.

The separate component can be fixedly connected to a radial internal side of the radially outer region and/or to a radial external side of the radially inner region.

The radially inner region on the radial external side thereof, and/or the radially outer region on the radial internal side thereof can in each case have grooves in each of which webs of the separate component engage by way of the end sides. There is the possibility that interference fits are in each case provided between the grooves and the ends of the webs, and/or the webs in the region of the grooves are in each case adhesively bonded, welded or by way of latching regions latched to the regions. In this instance, the separate component is able to be easily fixedly connected to the half-shell to the desirable extent.

The radially inner region of the half-shell on the radial internal side thereof and/or on the axial end side thereof can have a toothed profile by way of which the half-shell is able to be connected in a form-fitting manner to a toothed profile of the shaft of the electric motor, so as to in each case be able to transmit a torque in the desired manner.

The rotor according to the present disclosure can comprise a further half-shell which by way of the toroidal region thereof bears on the toroidal region of the half-shell and is fixedly connected to the half-shell. A rotor embodied in this manner is able to be made available inexpensively and with a high ratio of component strength to component weight, because the two half-shells are able to be embodied substantially as identical parts and have only to be disposed so as to be laterally reversed and connected to one another.

Depending on the respective specific application, and taking into account cost aspects and production aspects, there is the possibility to connect the half-shells to one another in a form-fitting, materially integral and/or friction-fitting manner.

There is furthermore the possibility that the radially outer regions and the toroidal regions of the half-shells in the cross section conjointly enclose in each case a right angle. The radially outer regions of the half-shells on the external side can be encompassed by a bracket-type component and in the axial direction and in the radial direction be fixedly connected to one another by the latter.

There is furthermore the possibility that radial external sides of the radially outer regions and the toroidal regions of the half-shells conjointly enclose in each case an obtuse angle. The radially outer regions of the half-shells on the external side can be encompassed by a component. The radial internal side of the component that faces the half-shells in the cross section can have an arrow-shaped profile which is adapted to the radial external sides of the radially outer regions of the half-shells. The two half-shells are able to be disposed in the desired manner so as to be mutually centered, and also held in desired positions in the radial direction, by way of a component of this type.

In a further advantageous embodiment of the rotor according to the present disclosure, the toroidal region of the half-shell in each case in relation to the axial external side thereof has corrugations which protrude in the direction of the toroidal region of the further half-shell. The corrugations of the toroidal region engage in a form-fitting manner in corrugations of the toroidal region of the further half-shell that are recessed in relation to the toroidal region of the half-shell. In this way, there is in each case a form-fit present between the toroidal regions of the half-shells in this embodiment of the rotor according to the present disclosure, by way of which form-fit a torque is in each case able to be transmitted between the two half-shells in an inexpensive manner which is simple in terms of construction.

Furthermore, there is the possibility that the toroidal region of the further half-shell in each case in relation to the axial external side thereof has corrugations which protrude in the direction of the toroidal region of the half-shell. The corrugations of the toroidal region of the further half-shell engage in a form-fitting manner in corrugations of the toroidal region of the half-shell that are recessed in relation to the toroidal region of the further half-shell. In this way, there are further form-fitting connections present between the toroidal regions of the two half-shells, which form-fitting connections enable the transmission of a torque in the circumferential direction. Furthermore, this embodiment of the rotor according to the present disclosure offers the possibility of again embodying the two half-shells as identical parts and of connecting them to one another in a form-fitting manner.

At least the recessed corrugations of the half-shells can in each case be provided in portions of the toroidal regions of the half-shells which do not form bearing surfaces for the webs of the separate components. In this instance, no clearances for the recessed corrugations are in each case to be provided in the region of the separate components, so as to be able to insert the separate components in the desired manner into the annular cavities of the half-shells, between the radially outer regions and the radially inner regions of the half-shells, and to assemble said separate components so as to bear on the toroidal regions of the half-shells.

The toroidal regions of the half-shells can in each case have clearances which are at least partially mutually congruent. In this instance, the rotor according to the present disclosure in the region of the toroidal regions is additionally able to be passed through by a flow of cooling medium without great complexity.

In an embodiment of the rotor according to the present disclosure, which is simple in terms of construction and able to be produced with little complexity and able to be assembled with little complexity, the radially outer region is configured to receive magnets. This is the case, for example, when the electric machine is configured as a radial flow machine.

Nevertheless, other construction modes of electric machines can also be implemented within the scope of the invention. For example, the rotor can be configured for configuring an axial flow machine; at least one toroidal region of the rotor can preferably be configured to receive magnets.

Provided according to a further aspect of the present disclosure is a method for producing a rotor described in more detail above, in which method the half-shells are produced by deep drawing or so-called flow forming. The separate components can be inexpensively produced by means of pultruding, forging and/or welding sheet metal segments. The half-shells are connected to the separate components in a form-fitting, force-fitting and/or materially integral manner.

In one advantageous variant of the method according to the present disclosure the half-shells are connected to one another in a form-fitting, force-fitting and/or materially integral manner.

Provided according to a further aspect of the present disclosure is a method for producing a half-shell of a rotor of an electric machine, having a hollow-cylindrical, radially outer region, having a hollow-cylindrical, radially inner region, and having a toroidal region which connects the radially outer region to the radially inner region. Additionally, the half-shell is produced with a plurality of webs which extend between the radially outer region and the radially inner region. The hollow-cylindrical regions, the toroidal region and the webs are produced as an integral component by means of forging.

According to one variant of the last-mentioned method, the toroidal regions of the half-shells are in each case able to be embodied with the corrugations described in more detail above during the forging process.

It is self-evident to a person skilled in the art that a feature described with reference to one of the above aspects may be applied to any other aspect, unless these are mutually exclusive. Furthermore, any feature described here may be applied to any aspect and/or combined with any other feature described here, unless these are mutually exclusive.

Embodiments will now be described, by way of example, with reference to the figures.

### IN THE FIGURES

FIG. 1 shows a highly simplified illustration of an electric machine;

FIG. 2 shows a three-dimensional partial view of a first embodiment of a rotor of the electric machine according to FIG. 1;

FIG. 3 shows a cross-sectional view of the rotor according to FIG. 2;

FIG. 4 shows an enlarged view of a region IV indicated more specifically in

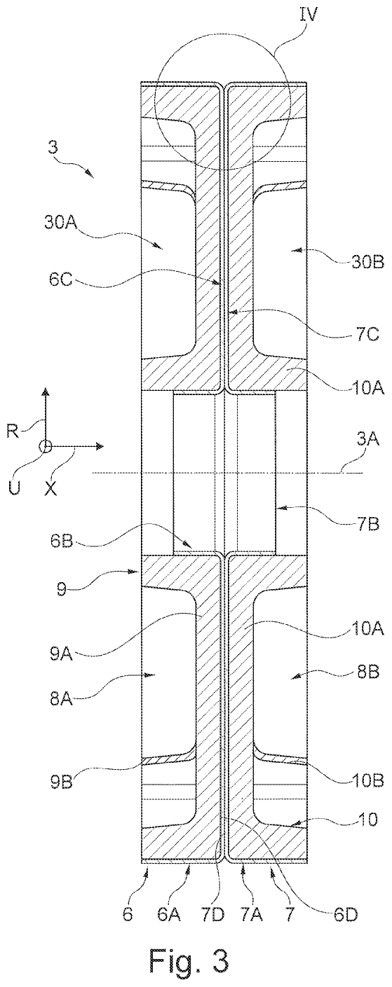

FIG. 3;

FIG. 5 shows a highly simplified view of the region IV having a component embodied in the manner of a bracket;

FIG. 6 shows an illustration corresponding to that of FIG. 5 of the region IV of a further embodiment of the rotor of the electric machine according to the present disclosure;

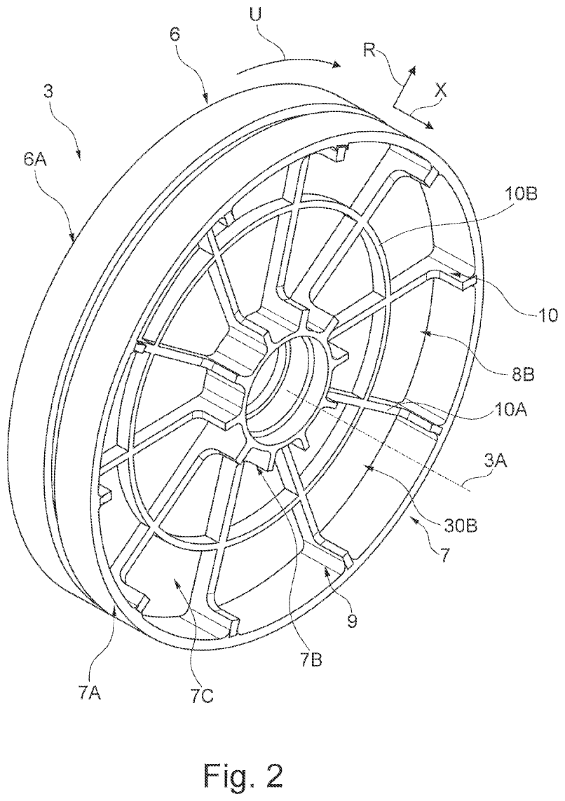

FIG. 7 shows an illustration corresponding to that of FIG. 3 of a further embodiment of the rotor according to FIG. 2;

FIG. 8 shows a simplified view of a region VIII, indicated more specifically in FIG. 7;

FIG. 9 shows a semi-finished product produced by means of extruding, from which a separate component of the rotor according to FIG. 2 is able to be produced;

FIG. 10 shows a three-dimensional stand-alone illustration of a separate component of the rotor according to FIG. 2;

FIG. 11 shows a stand-alone illustration of a further embodiment of the separate component of the rotor according to FIG. 2;

FIG. 12 shows a lateral view of the separate component according to FIG. 11;

FIG. 13 shows a partial sectional view of the rotor according to FIG. 7, in which two half-shells are connected to one another in a form-fitting manner by way of a plurality of rivets and corrugations provided so as to be distributed in the circumferential direction of the half-shells;

FIG. 14 shows a partially developed view of the toroidal regions of the half-shells of the rotor according to FIG. 13;

FIG. 15a shows an enlarged stand-alone illustration of a region XVa specified in FIG. 13, having a rivet; and

FIG. 15b shows an illustration corresponding to that of FIG. 15a of the rivet in the caulked state.

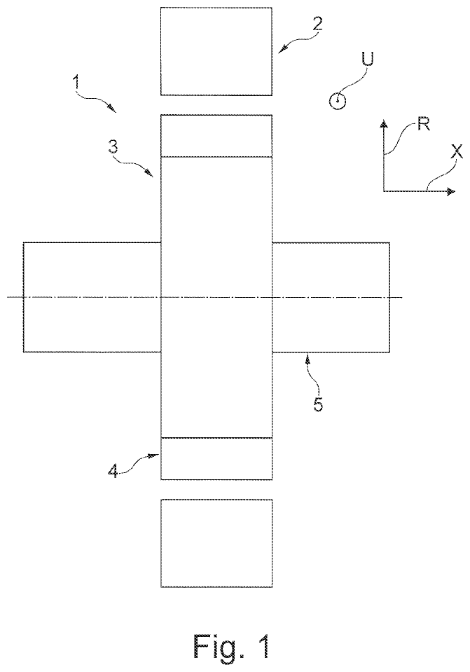

FIG. 1 shows an electric machine 1 having a stator 2, and having a rotor 3 which in the radial direction R is rotatably mounted within the stator 2. A plurality of magnets 4 are provided on the outer circumference of the rotor 3. Furthermore, the rotor 3 is co-rotationally connected to a shaft 5. The electric machine 1 can be embodied as an electric motor, or as a direct-drive motor for an aircraft, which is operated up to approximately 2500 rpm.

FIG. 2 shows a three-dimensional stand-alone view of a first embodiment of the rotor 3 which presently has two half-shells 6, 7. FIG. 3 additionally shows a cross-sectional view of the rotor 3 according to FIG. 2. It is derived from the illustration according to FIG. 3 that the two half-shells 6 and 7 are of substantially the same construction and have in each case a radially outer region 6A or 7A, a radially inner region 6B or 7B, and have in each case toroidal regions 6C or 7C which connect the radial regions 6A, 6B, or 7A, 7B to one another, respectively. The radial regions 6A to 7B are in each case of a hollow-cylindrical configuration and are embodied so as to be integral to the toroidal regions 6C or 7C, respectively.

A separate component 9 is fitted in an annular cavity 8A of the half-shell 6, which is delimited by the radially outer region 6A, by the radially inner region 6B, and by the toroidal region 6C. The separate component 9 is fixedly connected to the radially outer region 6A, to the radially inner region 6B, and to the toroidal region 6C, so as to increase overall the component stiffness of the half-shell 6. Additionally, a separate component 10, which is of substantially the same construction as the separate component 9 and is fixedly connected to the radially outer region 7A, to the radially inner region 7B, and to the toroidal region 7C of the half-shell 7, is also inserted into the half-shell 7.

The separate components 9 and 10 are embodied with a plurality of webs 9A or 10A which in the radial direction R extend between the radially inner regions 6B or 7B, and the radially outer regions 6A or 7A, and along the toroidal regions 6C and 7C, respectively, and form a star-shaped structure of the rotor 3. Additionally, the separate components 9 and 10 comprise circular webs 9B or 10B which run in the circumferential direction U, respectively. The webs 9B, 10B in the annular cavities 8A, 8B of the half-shells 6 and 7 run so as to be concentric with a rotation axis 3A of the rotor 3, and connect the webs 9A or 10A to one another, respectively. The webs 9B or 10B conjointly with the webs 9A or 10A, respectively, form in each case a spider web-like structure of the rotor 3, which corresponds substantially to a regular wheel net.

In the exemplary embodiment of the rotor 3 illustrated in FIG. 2 and FIG. 3, an axial height of the circular webs 9B, 10B of the separate components 9, 10 in the circumferential direction U of the rotor 3 is of identical size. In contrast, the axial heights of the webs 9A and 10A of the separate components 9 and 10 in the radial direction R of the rotor 3 vary. The height of the webs 9A and 10A running in the radial direction R in end regions of the webs 9A and 10A that face the radially outer regions 6A, 7A and the radially inner regions 6B and 7B is larger than in intervening portions.

In principle, there is the possibility of adapting the separate components 9 and 10 to the respective specific load and voltage path of the rotor 3, and of varying the profile of the webs 9A, 9B, 10A, 10B, the web width thereof and the web height thereof as a function of the load so as to embody in each case the rotor 3 with the desired component stiffness.

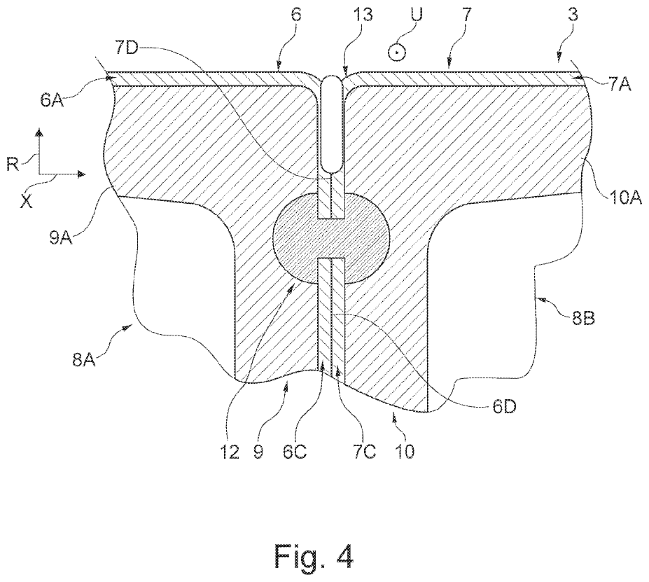

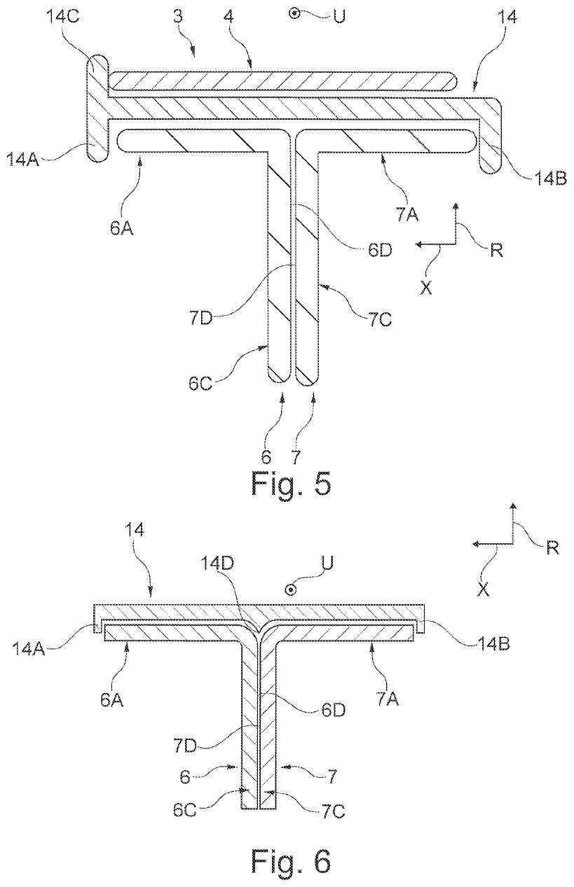

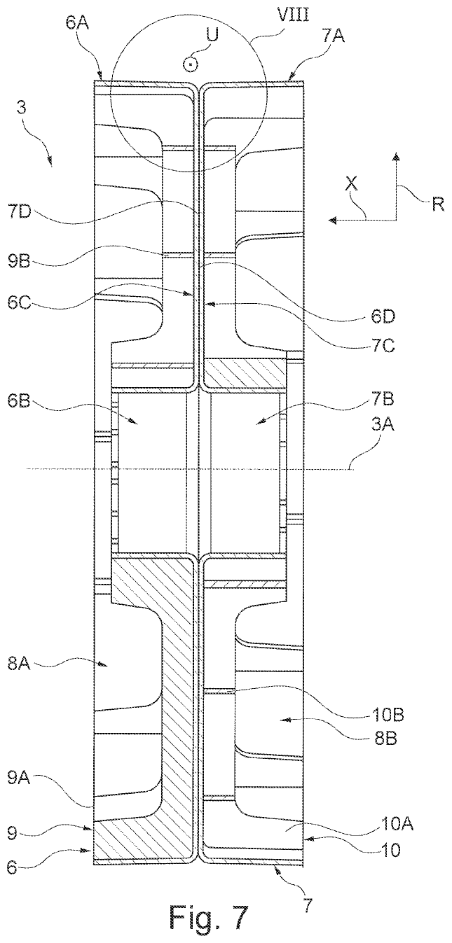

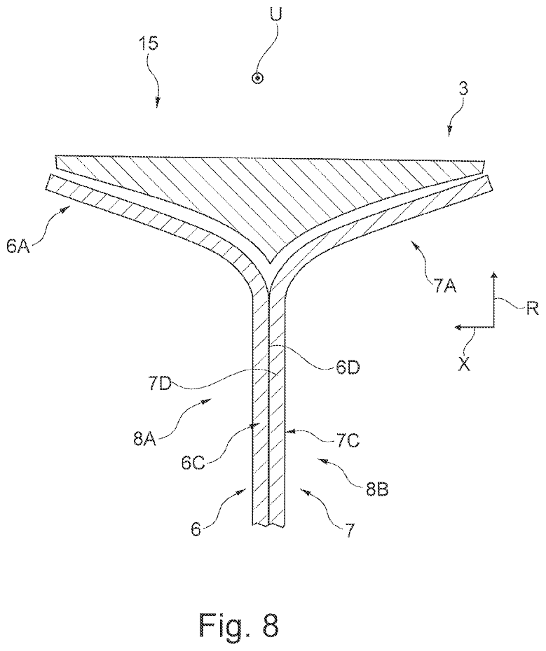

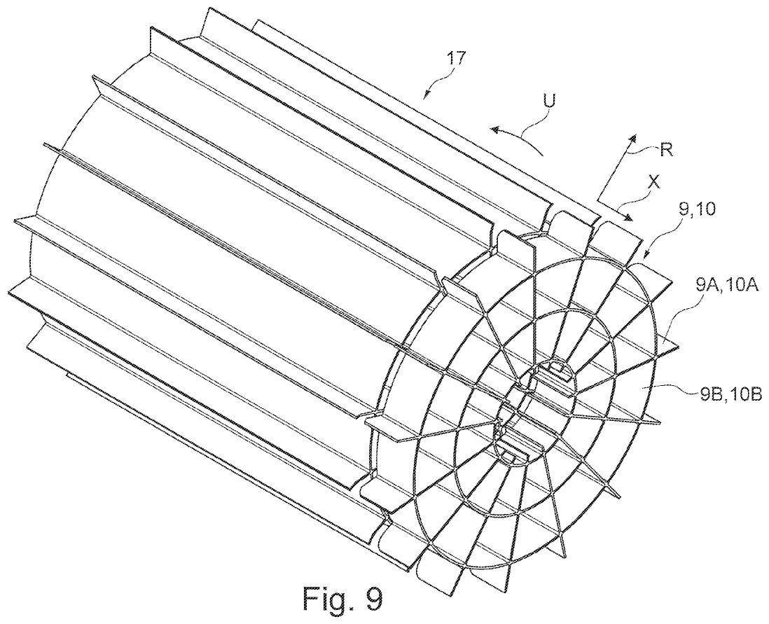

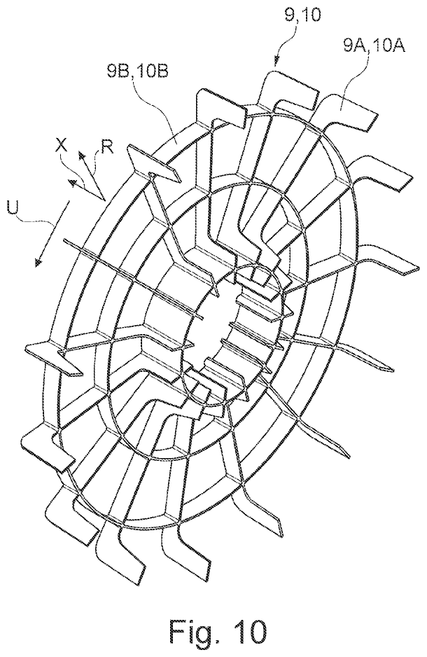

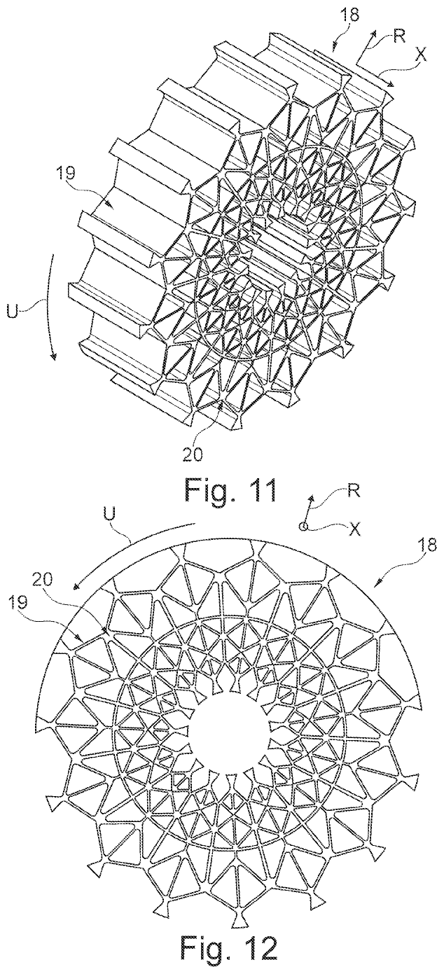

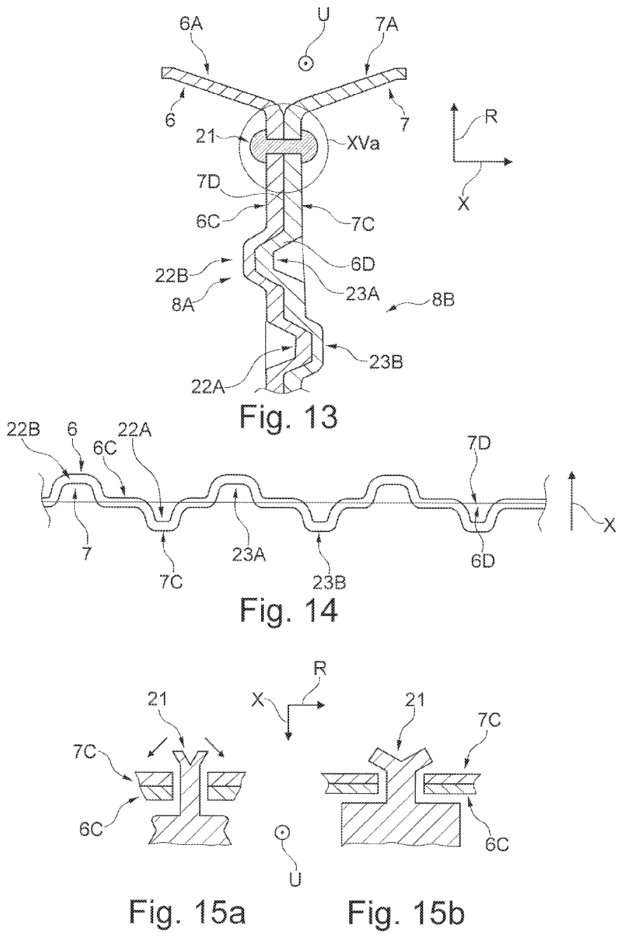

Shown in an enlarged view in FIG. 4 is a region IV indicated more specifically in FIG. 3. It can be derived from the illustration according to FIG. 4 that the toroidal regions 6C and 7C conjointly with the radially outer regions 6A, 7A of the half-shells 6, 7 enclose in each case a right angle. Additionally indicated in a highly simplified manner is a connection of the two half-shells 6 and 7 in the form of a rivet connection 12 which is provided so as to be radially within the radially outer regions 6A and 7A. Moreover, the half-shells 6 and 7 in the transition region between the radially outer regions 6A and 7A and the toroidal regions 6C, 7C are fixedly connected in a materially integral manner by way of a weld seam 13, the latter being shown only in a highly simplified manner in FIG. 4.

FIG. 5 shows a highly simplified illustration of the region IV in a further embodiment of the rotor 3, in which the radially outer regions 6A and 7A of the half-shells 6 and 7 are in each case embraced by a bracket-type component 14 in the radial direction R from the outside and in the circumferential direction U. The bracket-type component 14 here, by way of radially inward-directed annular bead-shaped portions 14A, 14B, protrudes laterally beyond the two radially outer regions 6A and 7A of the half-shells 6 and 7.

Depending on the respective specific application, there is by way of the bracket-type component 14 the possibility of impinging the half-shells 6 and 7 via the annular bead-shaped portions 14A, 14B with a clamping force that acts inward in an axial direction X of the rotor 3, of mutually compressing the half-shells 6 and 7 in the axial direction X, and of connecting said half-shells 6 and 7 to one another in a force-fitting and form-fitting manner. Additionally, the bracket-type component 14, at least on one side, can be configured with a further annular bead 14C which protrudes outward in the radial direction R. The further annular bead 14C can be provided as a centering detent for the magnets 4 to be attached to the radial external side of the rotor 3.

FIG. 6 shows a further embodiment of the rotor 3 in an illustration corresponding to that of FIG. 5, in which the bracket-type component 14 on the radial internal side thereof that faces the half-shells 6 and 7 is configured with a centering bead 14D. Self-adjusting of the bracket-type component 14 on the half-shells 6, 7 is able to be implemented in a simple manner in terms of construction by way of the centering bead 14D.

FIG. 7 shows an illustration corresponding to that of FIG. 3 of a further embodiment of the rotor 3, in which the radially outer regions 6A and 7A conjointly with the toroidal regions 6C or 7C of the half-shells 6 and 7 enclose in each case an obtuse angle, respectively. The obtuse angle between the toroidal regions 6C and 7C and the radially outer regions 6A and 7A here is only slightly larger than 90°, and can be for example 92° to 95°. The obtuse angle between the radially outer regions 6A, 7A and the annular regions 6C, 7C for producing the half-shells 6 and 7 by means of deep drawing offers the possibility to provide in each case demolding ramps on the external diameter of the half-shells 6 and 7. In such an embodiment of the rotor 3, a positioning piece 15 can be provided so as to be radially external on the half-shells 6 and 7, the radial internal side 16 of said positioning piece 15 in the cross section being embodied in the shape of an arrow, said cross section being shown more specifically in FIG. 8, the latter showing an enlarged view of a region VIII indicated more specifically in FIG. 7. As a result, assembling of the positioning piece 15 on the external sides of the half-shells 6 and 7 is able to be carried out in a simple manner.

FIG. 9 shows a semi-finished product 17 which is produced by means of strand casting and from which the separate components 9 and 10 are in each case able to be produced as blanks cut to variable lengths.

If the height of the webs 9A, 9B, 10A, 10B of the separate components 9 and 10 is to be varied in the radial direction R and in the circumferential direction U, as is illustrated in FIG. 10, the blanks of the semi-finished product 17 can be adapted so as to correspond to the respective load conditions, for example by means of turning or forging.

FIG. 11 and FIG. 12 show a further embodiment of a separate component 18 which comprises a multiplicity of webs 19 with different orientations in the radial direction R and/or in the circumferential direction U, and which is able to be used in the half-shells 6, 7 of the rotor 3. The webs 19 are in each case fixedly connected to one another in the region of so-called nodes 20. The separate component 18 can be inexpensively produced by means of a strand casting method or else by means of a pultrusion method. The nodes 20 are in each case preferably disposed in groups so as to be uniformly mutually spaced apart on circles in the manner illustrated in FIG. 11 and FIG. 12. The different groups of nodes 20 lie in each case on circles which have different radii and are disposed so as to be concentric with the rotation axis 3A. In this way, the rotor 3, if embodied with the component 18, in regions has star-shaped and in regions also spider web-like structures, which contribute substantially toward the component strength of the rotor 3.

FIG. 13 again shows an illustration corresponding to that of FIG. 4 of a further embodiment of the rotor 3, in which the half-shells 6 and 7 are fixedly connected to one another by way of rivets 21 and by way of corrugations 22A, 22B, 23A, 23B. Through bores 24, 25 in the toroidal regions 6C, 7C of the half-shells 6 and 7 can be incorporated into the toroidal regions 6C and 7C by means of punching, boring, laser cutting, or the like.

The corrugations 22A, 22B, 23A, 23B are provided in the region of the toroidal regions 6C and 7C of the half-shells 6 and 7. The corrugations 22A of the toroidal region 6C of the half-shell 6 here protrude in relation to an axial external side 6D of the toroidal region 6C, and in the axial direction X protrude in the direction of the toroidal region 7C of the further half-shell 7. In contrast, the corrugations 22B in the axial direction X are recessed in relation to the axial external side 6D. Furthermore, the toroidal region 7C is also configured with corrugations 23A which, in the manner shown in more detail in FIG. 14, in the axial direction X protrude in relation to the axial external side 7D of said toroidal region 7C, and with corrugations 23B which are recessed in relation to the axial external side 7D.

FIG. 14 shows a partially developed view of the toroidal regions 6C and 7C, having the respective protruding corrugations 22A or 23A, and the respective recessed corrugations 23A and 23B. It can be derived from the illustration according to FIG. 14 that the respective protruding corrugations 22A and 23A engage in each case in the recessed corrugations 22B and 23B of the toroidal regions 6C and 7C, and configure a form-fit between the two half-shells 6 and 7. As a result, a torque is able to be transmitted in the circumferential direction U between the half-shells 6 and 7. The corrugations 22A to 22B of the half-shells 6 and 7 are able to be incorporated into the toroidal regions 6C and 7C by way of an embossing process, or already during deep drawing of the half-shells 6, 7, for example.

FIG. 15a shows a region XVa, illustrated in FIG. 13, of the toroidal regions 6C, 7C of the half-shells 6, 7, in which the rivet 21 penetrates the toroidal regions 6C, 7C of the half-shells 6, 7. The rivet 21 in FIG. 15a here is illustrated in a non-caulked state, while FIG. 15b illustrates the rivet 21 after caulking.

The webs 9A, 9B, or 10A, 10B of the separate components 9 and 10 delimit in each case so-called windows 30A, 30B of the toroidal regions 6C or 7C, respectively. The corrugations 22A to 22B as well as further connecting elements such as those of the rivet connection 12, or the rivet 21, for fixedly connecting the two half-shells 6 and 7, are able to be provided in a simple manner in the region of the windows 30A, 30B, without compromising or impeding the separate components bearing on the toroidal regions 6C and 7C.

Furthermore, there is also the possibility of providing cut-outs in the region of the windows 30A, 30B so as to be able to cool the rotor 3 in the desired manner, and to be able to direct cooling medium, for example air or the like, through the clearances.

### LIST OF REFERENCE SIGNS

1 Electric motor
2 Stator
3 Rotor
3A Rotation axis of the rotor
4 Magnet
5 Shaft
6 Half-shell
6A Radially outer region of the half-shell 6
6B Radially inner region of the half-shell 6
6C Toroidal region of the half-shell 6
6D Axial external side of the half-shell 6
7 Further half-shell
7A Radially outer region of the further half-shell 7
7B Radially inner region of the further half-shell 7
7C Toroidal region of the further half-shell 7
7D Axial external side of the further half-shell 7
8A Cavity of the half-shell 6
8B Cavity of the half-shell 7
9 Separate component of the half-shell 6
9A Web of the separate component 9
9B Web of the separate component 9
10 Separate component of the half-shell 7
10A Web of the separate component 10
10B Web of the separate component 10
12 Rivet connection
13 Welded connection
14 Bracket-type component
14A, 14B Annular bead-shaped portion
14C Further annular bead-shaped portion
14D Centering bead
15 Positioning piece
16 Radial internal side
17 Semi-finished product
18 Separate component
19 Webs of the separate component 18
20 Node of the separate component 18
21 Rivet
22A Protruding corrugation of the half-shell 6
22B Recessed corrugation of the half-shell 6
23A Protruding corrugation of the half-shell 7
23B Recessed corrugation of the half-shell 7
30A, 30B Window
R Radial direction
U Circumferential direction
X Axial direction

1. A rotor of an electric machine, having at least one half-shell which comprises a hollow-cylindrical, radially inner region, a hollow-cylindrical, radially outer region, and a toroidal region which in the radial direction and in the circumferential direction extends between the radially inner region and the radially outer region;
wherein the toroidal region connects the radial regions to one another;
wherein the radially inner region is able to be co-rotationally connected to a shaft of the electric machine;
wherein the radially inner region, the radially outer region and the toroidal region are integrally embodied;
and wherein the half-shell is reinforced by a separate component which is fixedly connected to the half-sheThl and comprises webs which extend between the radially inner region and the radially outer region.

2. The rotor according to claim 1, wherein at least one of the webs in the circumferential direction extends between the radially inner region and the radially outer region, has a circular profile, and connects further webs of the separate component to one another.

3. The rotor according to claim 2, wherein at least one of the webs, between the radially inner region and the radially outer region, at least in regions has a radial profile.

4. The rotor according to claim 2, wherein the profiles of the webs of the separate component at least in regions form a spider web-like and/or a star-shaped structure of the separate component.

5. The rotor according to claim 1, wherein a height of the webs of the separate component varies in the radial direction between the radially inner region and the radially outer region.

6. The rotor according to claim 1, wherein the separate component is fixedly connected to a radial internal side of the radially outer region of the half-shell.

7. The rotor according to claim 1, wherein the separate component is fixedly connected to a radial external side of the radially inner region of the half-shell.

8. The rotor according to claim 1, wherein the radially inner region of the half-shell on the radial external side thereof and/or the radially outer region on the radial internal side thereof have/has in each case grooves in which webs of the separate component engage by way of the end sides, wherein interference fits are in each case provided between the grooves and the ends of the webs, and/or the webs in the region of the grooves are in each case adhesively bonded, welded, or by way of latching regions latched to the radial regions.

9. The rotor according to claim 1, wherein the radially inner region of the half-shell, on the radial internal side thereof and/or on the axial end side thereof, has a toothed profile.

10. The rotor according to claim 1, wherein provided is a further half-shell which by way of the toroidal region thereof bears on the toroidal region of the half-shell and is fixedly connected to the half-shell.

11. The rotor according to claim 1, wherein the half-shells are connected to one another in a form-fitting, materially integral and/or friction-fitting manner.

12. The rotor according to claim 1, wherein the radially outer regions and the toroidal regions of the half-shells in the cross section conjointly enclose in each case a right angle, wherein the radially outer regions of the half-shells on the external side are encompassed by a bracket-type component.

13. The rotor according to claim 1, wherein radial external sides of the radially outer regions and the toroidal regions of the half-shells conjointly enclose in each case an obtuse angle, wherein the radially outer regions of the half-shells on the external side are encompassed by a component of which the radial internal side thereof that faces the half-shells in the cross section has an arrow-shaped profile which is adapted to the radial external sides of the radially outer regions of the half-shells.

14. The rotor according to claim 1, wherein the toroidal region of the half-shell in each case in relation to the axial external side thereof has corrugations which protrude in the direction of the toroidal region of the further half-shell and which engage in a form-fitting manner in corrugations of the toroidal region of the further half-shell that are recessed in relation to the toroidal region of the half-shell.

15. The rotor according to claim 1, wherein the toroidal region of the further half-shell in each case in relation to the axial external side thereof has corrugations which protrude in the direction of the toroidal region of the half-shell and which engage in a form-fitting manner in corrugations of the toroidal region of the half-shell that are recessed in relation to the toroidal region of the further half-shell.

16. The rotor according to claim 1, wherein at least the recessed corrugations are in each case provided in portions of the toroidal regions of the half-shells which do not form bearing surfaces for the webs of the separate components.

17. The rotor according to claim 1, wherein the toroidal regions of the half-shells have clearances which are at least partially mutually congruent.

18. The rotor according to claim 1, wherein the radially outer region is configured to receive magnets.

19. A method for producing a rotor according to claim 1, comprising the following method steps:
manufacturing the half-shells by means of deep drawing or flow forming;
manufacturing the separate component by means of strand casting, pultruding, forging and/or welding sheet metal segments;
connecting in a form-fitting, force-fitting and/or materially integral manner the half-shell to the separate component.

20. The method according to claim 19, wherein the half-shells are connected to one another in a form-fitting, force-fitting and/or materially integral manner.

21. A method for producing a half-shell of a rotor of an electric machine, having a hollow-cylindrical, radially outer region, having a hollow-cylindrical, radially inner region, and having a toroidal region which connects the radially outer region to the radially inner region, and having a plurality of webs which extend between the radially outer region and the radially inner region;
wherein the hollow-cylindrical regions, the toroidal region and the webs are produced as an integral component by means of forging.
